(19) United States
(12) Patent Application Publication
(10) Pub. No.: US 2018/0180867 A1
(43) Pub. Date: Jun. 28, 2018

(54) MICROSCOPE AND SETTING SUPPORT METHOD

(71) Applicant: OLYMPUS CORPORATION, Tokyo (JP)

(72) Inventor: Yoshihiro SHIMADA, Sagamihara (JP)

(73) Assignee: OLYMPUS CORPORATION, Tokyo (JP)

(21) Appl. No.: 15/800,908

(22) Filed: Nov. 1, 2017

(30) Foreign Application Priority Data
Dec. 22, 2016 (JP) 2016-249899

(51) Int. Cl. G02B 21/36; G02B 21/06; G02B 21/02

(52) U.S. Cl. CPC G02B 21/364; G02B 21/025; G02B 21/06

(57) ABSTRACT

A microscope includes: a first illumination optical system that illuminates a sample from a first direction that is substantially orthogonal to an optical axis of a first objective, and that forms a first illumination region within the sample; a first imaging optical system that images the sample in accordance with light that has been generated from the first illumination region; a second illumination optical system that illuminates the sample from a second direction that is substantially orthogonal to the optical axis of the first objective; and a second imaging optical system that images the sample in accordance with light emitted from the second illumination optical system.

### CROSS REFERENCE TO RELATED APPLICATIONS

This application is based upon and claims the benefit of priority from the prior Japanese Patent Application No. 2016-249899, filed on Dec. 22, 2016, the entire contents of which are incorporated herein by this reference.

### BACKGROUND OF THE INVENTION

### Field of the Invention

The present invention relates to a microscope and a setting support method.

### Description of the Related Art

In the field of fluorescence microscopes, a light sheet microscope is known that irradiates a sample with a laser beam from a direction that is substantially orthogonal to an observation optical axis (namely, the optical axis of an objective) so as to form a light sheet in the sample. The light sheet microscope is described, for example, in International Publication Pamphlet No. WO 2008/125204. The light sheet microscope can obtain an image at a higher speed than the speed of a scanning microscope that performs point scanning or the like. In addition, the light sheet microscope does not apply light to any portions other than an imaging plane, and therefore a fluorescent material can be suppressed from discoloring, and a satisfactory three-dimensional stereoscopic image can be obtained.

In recent years, the light sheet microscope has not been used only to obtain a stereoscopic image of a living thing such as a zebrafish in which a target molecule is labeled by a fluorescent protein. The light sheet microscope is expected to be applied to a wide range of applications, and as an example, the light sheet microscope has been attracting attention as a technology that aims at application to so-called “drug discovery screening” for obtaining a three-dimensional stereoscopic image of a three-dimensional cultured cell such as a spheroid or an organoid, and for evaluating beneficial effects by using an image analysis technology.

### SUMMARY OF THE INVENTION

A microscope in one aspect of the present invention includes: a first illumination optical system that illuminates a sample from a first direction that is substantially orthogonal to an optical axis of a first objective, and that forms a first illumination region within the sample; a first imaging optical system that includes the first objective, the first imaging optical system imaging the sample in accordance with light that has been generated from the first illumination region formed by the first illumination optical system; a second illumination optical system that illuminates the sample from a second direction that is substantially orthogonal to the optical axis of the first objective; and a second imaging optical system that includes a second objective having an optical axis that is substantially orthogonal to the optical axis of the first objective, the second imaging optical system imaging the sample in accordance with light emitted from the second illumination optical system.

A setting support method in one aspect of the present invention is a setting support method that supports a task of setting a region to be imaged by using a microscope that images, via a first objective, a sample illuminated from a first direction that is substantially orthogonal to an optical axis of the first objective. The setting support method includes: illuminating the sample from a second direction that is substantially orthogonal to the optical axis of the first objective; and imaging the sample illuminated from the second direction via a second objective having an optical axis that is substantially orthogonal to the optical axis of the first objective.

### BRIEF DESCRIPTION OF THE DRAWINGS

The present invention will be more apparent from the following detailed description when the accompanying drawings are referenced.

FIG. 1 illustrates the configuration of a microscope 1 according to a first embodiment.

FIG. 2 is a diagram explaining the configuration of a sample container H.

FIG. 3 illustrates the hardware configuration of a controller 10.

FIG. 4 is an example of a flowchart of three-dimensional image construction processing.

FIG. 5 illustrates an example of a screen that is displayed on a display device 30 in order to support setting.

FIG. 6 illustrates another example of the screen that is displayed on the display device 30 in order to support setting.

FIG. 7 illustrates yet another example of the screen that is displayed on the display device 30 in order to support setting.

FIG. 8 illustrates yet another example of the screen that is displayed on the display device 30 in order to support setting.

FIG. 9 illustrates yet another example of the screen that is displayed on the display device 30 in order to support setting.

FIG. 10 illustrates the configuration of a microscope body 200 according to a second embodiment.

FIG. 11 illustrates the configuration of a microscope body 300 according to a third embodiment.

FIG. 12 illustrates the configuration of a microscope body 400 according to a fourth embodiment.

FIG. 13 is a diagram explaining the configuration of a diaphragm 416.

FIG. 14 illustrates yet another example of the screen that is displayed on the display device 30 in order to support setting.

FIG. 15 illustrates yet another example of the screen that is displayed on the display device 30 in order to support setting.

FIG. 16 illustrates yet another example of the screen that is displayed on the display device 30 in order to support setting.

FIG. 17 illustrates yet another example of the screen that is displayed on the display device 30 in order to support setting.

FIG. 18 illustrates yet another example of the screen that is displayed on the display device 30 in order to support setting.

### DESCRIPTION OF THE EMBODIMENTS

The light sheet microscope usually constructs a three-dimensional stereoscopic image by performing image processing on a plurality of tomographic images that are obtained in a state in which a sample or a light sheet applied to the sample is being moved along an observation optical axis. A three-dimensional stereoscopic image of the entirety of the sample is not always constructed, and a region to be imaged is set according to the intended use of a three-dimensional stereoscopic image, time constraints, or the like.

However, it is not easy to accurately set the region to be imaged in such a way that the region to be imaged is a desired three-dimensional region in the sample. It is extremely difficult to accurately set the region to be imaged, in particular, in a depth direction. This is because it is difficult to grasp in advance which range (in particular, which depth range) in the sample an illumination region in which the light sheet is formed is located within.

As an example, International Publication Pamphlet No. WO 2008/125204 discloses a method for detecting a relative positional relationship between a light sheet and a focal plane of an observation optical system. However, the technology described in International Publication Pamphlet No. WO 2008/125204 is not a technology for supporting the grasping of a relative positional relationship between a sample and an illumination region.

In view of the above circumstances, embodiments of the present invention are described below.

### First Embodiment

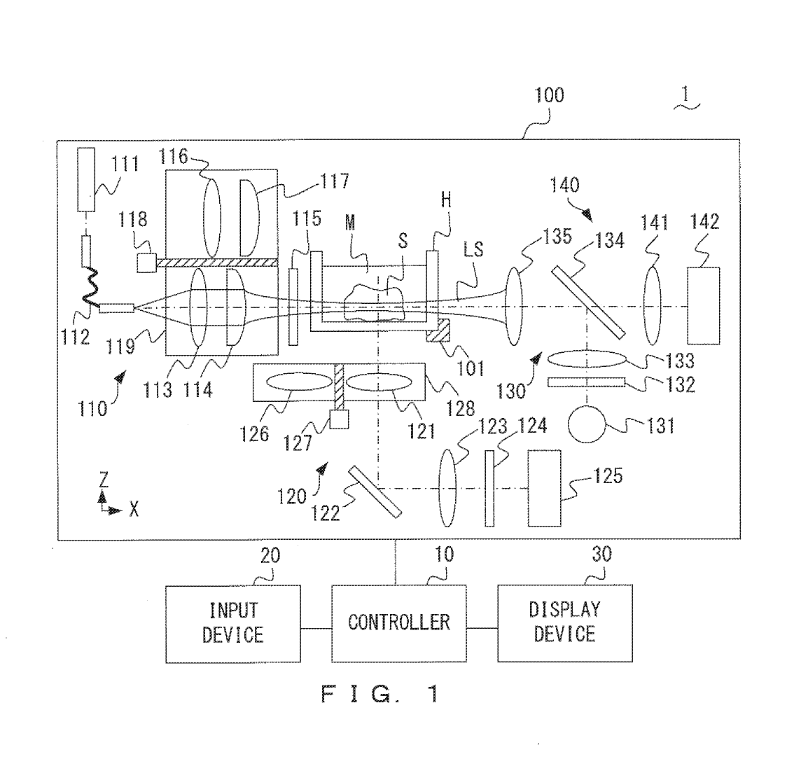

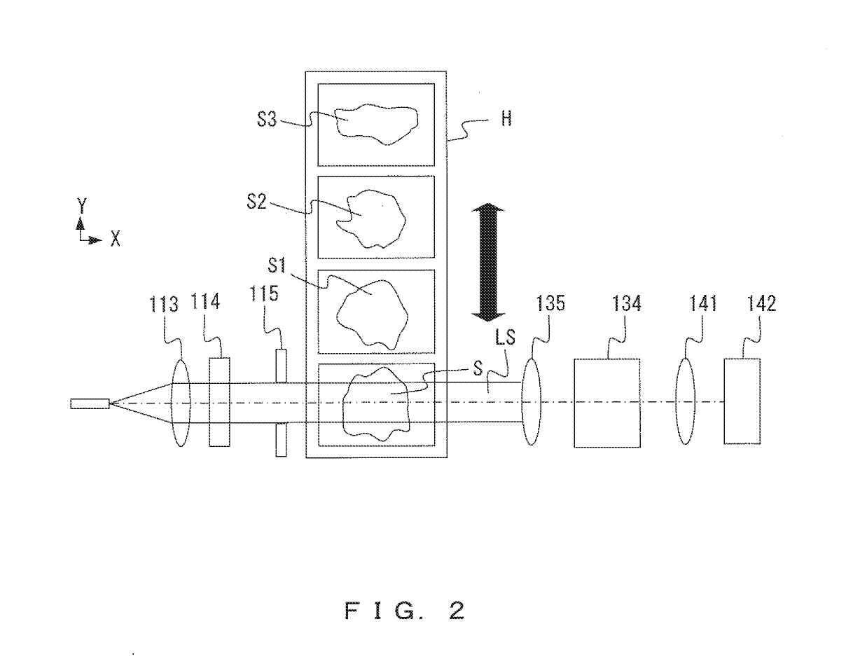

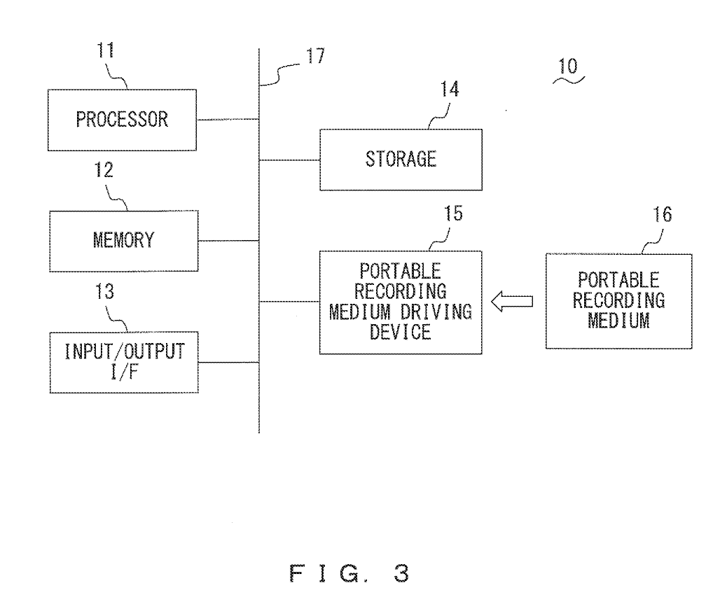

FIG. 1 illustrates the configuration of a microscope 1 according to this embodiment. FIG. 2 is a diagram explaining the configuration of a sample container H. FIG. 3 illustrates the hardware configuration of a controller 10. An XYZ coordinate system illustrated in FIG. 1 and FIG. 2 is an orthogonal coordinate system provided for convenience of direction reference.

A microscope 1 is a light sheet microscope that constructs a three-dimensional image by using a tomographic image of a sample S that is obtained by applying a light sheet LS. The sample S is, for example, a biological cell labeled by a fluorochrome. The sample S is transparentized by a medium M serving as a transparentizing solution that is stored together with the sample in a sample container H. The light sheet is illumination light that forms a sheet-shape illumination region.

The sample container H has a multiwell structure that is sectioned into 1×4 regions, as illustrated in FIG. 2. A sample (a sample S, a sample S1, a sample S2, or a sample S3) is stored in each well of the sample container H in a state in which the sample is immersed in the medium M. A plurality of wells of the sample container H are aligned in a Y-direction that is orthogonal to an X-direction in which the light sheet LS enters. Therefore, an electric stage 101 moves in the Y-direction, and the sample container H placed on the electric stage 101 moves together with the electric stage 101 in the Y-direction such that a sample to be imaged can be switched. Both surfaces of the sample container H, which are respectively an incident surface and an emission surface of the light sheet, are surfaces parallel to the Y-direction in which the wells are aligned, and are orthogonal to an incident direction (the X-direction) of the light sheet. In the sample container H, at least both surfaces that the light sheet passes through are made of a material that transmits light.

The microscope 1 includes a microscope body 100, a controller 10, an input device 20, and a display device 30, as illustrated in FIG. 1. The controller 10 is connected to the microscope body 100, the input device 20, and the display device 30, and the controller 10 controls the operations of these components.

The microscope body 100 includes an illumination optical system 110 that irradiates the sample S with the light sheet LS, and an imaging optical system 120 that obtains a fluorescence image of the sample S.

The illumination optical system 110 is a first illumination optical system of the microscope 1. The illumination optical system 110 includes a laser 111, an optical fiber 112, an optical system (a lens 113, a cylindrical lens 114, a lens 116, and a cylindrical lens 117) that is housed in a turret 119, and a diaphragm 115. A driving device 118 is provided in the turret 119. The driving device 118 rotates the turret 119 according to an instruction from the controller 10 so as to switch an optical system to be arranged on an illumination optical path. Optical systems having different exit numerical apertures (exit NAs) are housed in the turret 119. By switching the optical systems having different exit NAs, the size (thickness and length) of the illumination region described later that has a sheet shape can be changed.

The laser 111 is a visible laser that emits visible light, and the laser 111 emits, for example, a laser beam that has a wavelength of 488 nm. The ON/OFF state of the laser 111 and the intensity of the laser beam are controlled by the controller 10. The laser beam is guided to the optical fiber 112 via a collecting optical system that is not illustrated. The laser beam that has exited from the optical fiber 112 enters the optical system housed in the turret 119, and is converted into the light sheet LS. More specifically, the laser beam is collimated by the lens 113 (or the lens 116), and is converted into the light sheet LS that has a thin sheet shape in a Z-direction by the cylindrical lens 114 (or the cylindrical lens 117). The light sheet LS is applied to the sample S after light that will illuminate an unneeded region (for example, a region outside a visual field range of the imaging optical system 120) is shielded by the diaphragm 115. By doing this, an illumination region (a first illumination region) that has a sheet shape is formed within the sample S. Stated another way, the illumination optical system 110 forms the illumination region by using the light sheet LS. The aperture diameter of the diaphragm 115 is controlled by the controller 10.

The imaging optical system 120 is a first imaging optical system of the microscope 1. The imaging optical system 120 includes objectives (an objective 121 and an objective 126) that are housed in a turret 128, a mirror 122, a tube lens 123, an emission filter 124, and an imaging device 125. A driving device 127 is provided in the turret 128. The driving device 127 rotates the turret 128 according to an instruction from the controller 10 so as to switch an objective to be arranged on an imaging optical path. Objectives having different magnifications (for example, a 1× objective and a 10× objective) are housed in the turret 128.

The objective 121 and the objective 126 are infinity-corrected objectives, and are first objectives of the microscope 1. The sample S that is irradiated with the light sheet LS by the illumination optical system 110 generates fluorescence in the illumination region to which the light sheet LS is applied. The fluorescence generated from the illumination region enters the objective 121, and is converted into a parallel light flux by the objective 121. The fluorescence enters the tube lens 123 via the mirror 122. The tube lens 123 collects the fluorescence so as to form an optical image on the imaging device 125. The laser beam that has been scattered by the sample S and has entered the imaging optical system 120 together with the fluorescence is shielded by the emission filter 124. The imaging device 125 is, for example, a digital camera that includes a two-dimensional image sensor such as a charge coupled device (CCD) or a complementary metal oxide semiconductor (CMOS). The imaging device 125 generates fluorescence image data on the basis of the optical image, and transmits the generated fluorescence image data to the controller 10.

The illumination optical system 110 and the imaging optical system 120 that are configured as described above are arranged in such a way that their optical axes are substantially orthogonal to each other. More specifically, the illumination optical system 110 and the imaging optical system 120 are provided in such a way that the illumination optical axis of the illumination optical system 110 is substantially orthogonal to the optical axis of the objective 121 included in the imaging optical system. 120. Therefore, in the microscope body 100, the illumination optical system 110 illuminates the sample S from a direction (a first direction) that is substantially orthogonal to the optical axis of the objective 121, and the illumination optical system 110 forms an illumination region that has a thin sheet shape in a direction of the optical axis of the objective 121 within the sample S.

The cylindrical lens (the cylindrical lens 114 or the cylindrical lens 117) is arranged in such a way that the illumination optical axis of the illumination optical system 110 and the optical axis of the imaging optical system 120 (the optical axis of the objective 121) cross each other near a focal position of the cylindrical lens. By doing this, in the microscope body 100, the imaging optical system 120 can image the sample S on the basis of the fluorescence generated from the illumination region, and can obtain a fluorescence image of the sample S.

The illumination region formed by the illumination optical system 110 has a thin sheet shape in a direction of the optical axis of the objective 121, and therefore the fluorescence image is a tomographic image of the sample S. The phrase “substantially orthogonal” means a range that those skilled in the art can recognize as errors in setting or manufacturing from an orthogonal state, and includes orthogonality. In addition, the phrase “the illumination optical axis of the illumination optical system 110 and the optical axis of the imaging optical system 120 cross each other near a focal position of the cylindrical lens” means that the optical axis of the imaging optical system 120 is located at least within the illumination region formed by the cylindrical lens, and includes that the focal position of the cylindrical lens is located on the optical axis of the imaging optical system 120.

The microscope body 100 further includes an illumination optical system 130 and an imaging optical system 140. The illumination optical system 130 is a second illumination optical system of the microscope 1, and the illumination optical system 130 illuminates the sample S from a direction that is substantially orthogonal to the optical axis of the objective 121. The imaging optical system 140 is a second imaging optical system of the microscope 1, and the imaging optical system 140 images the sample S on the basis of light emitted from the illumination optical system 130.

The illumination optical system 110 and the imaging optical system. 120 are configured to obtain a tomographic image of the sample S, and the illumination optical system 130 and the imaging optical system 140 are configured to obtain an image of the sample S viewed from the side. The illumination optical system 110 irradiates the sample S with visible light, and the illumination optical system 130 irradiates the sample S with near-infrared light. Stated another way, the wavelength of light with which the illumination optical system 130 irradiates the sample S is longer than the wavelength of light with which the illumination optical system 110 irradiates the sample S.

The illumination optical system 130 is a reflection illumination optical system that shares some optical elements with the imaging optical system 140. The illumination optical system 130 includes a light source 131, a wavelength selection filter 132, an illumination lens 133, a half mirror 134, and an objective 135.

The light source 131 is, for example, a halogen lamp, and the light emission of the light source 131 is controlled by the controller 10. The wavelength selection filter 132 transmits light having a wavelength that does not excite a fluorescent material in the sample S of light emitted from the light source 131, and more specifically, near-infrared light having a wavelength longer than the excitation wavelength of the sample S. The near-infrared light enters the objective 135 via the illumination lens 133 and the half mirror 134. The objective 135 is an infinity-corrected objective of a low magnification (for example, 1×), and is a second objective of the microscope 1. The objective 135 is arranged in such a way that the objective 135 has an optical axis that is substantially orthogonal to the optical axis of the objective 121. The near-infrared light is applied to the sample S by the objective 135. By doing this, the sample S is illuminated from a direction that is substantially orthogonal to the optical axis of the objective 121.

The imaging optical system 140 includes the objective 135, the half mirror 134, a tube lens 141, and an imaging device 142. The objective 135 and the half mirror 134 are shared with the illumination optical system 130.

Near-infrared light reflected by the sample S of the near-infrared light emitted by the illumination optical system 130 enters the tube lens 141 via the objective 135 and the half mirror 134. The tube lens 141 collects the near-infrared light so as to form an optical image on the imaging device 142. The imaging device 142 is, for example, a digital camera including a two-dimensional image sensor such as a charge coupled device (CCD) or a complementary metal oxide semiconductor (CMOS). The imaging device 142 generates bright-field image data on the basis of the optical image, and transmits the generated bright-field image data to the controller 10.

As described above, the illumination optical system 130 and the imaging optical system 140 share the objective 135, which has an optical axis that is substantially orthogonal to the optical axis of the objective 121. Therefore, the microscope body 100 can illuminate the sample S from a direction (a second direction) that is substantially orthogonal to the optical axis of the objective 121, and can obtain an image of the sample S viewed from the side. In addition, the objective 135 is an objective of a low magnification, and therefore an image of the entirety of the sample S can be obtained.

Further, the objective 135 and the illumination optical system 110 are arranged so as to face each other across the sample S. More specifically, the optical axis of the objective 135 and the illumination optical axis of the illumination optical system. 110 are located on the same axis. The arrangement above of the objective 135 enables a sample to be illuminated and imaged from the side, whichever sample of a plurality of samples housed in the sample container H is observed.

The controller 10 is, for example, a standard computer. The controller 10 includes a processor 11, a memory 12, an input/output interface 13, a storage 14, and a portable recording medium driving device 15 into which a portable recording medium 16 is inserted, as illustrated in FIG. 3, and these components are connected to each other via a bus 17.

The processor 11 is, for example, a central processing unit (CPU), a micro processing unit (MPU), a digital signal processor (DSP), or the like, and the processor 11 executes a program so as to perform programmed processing such as the three-dimensional image construction processing described later. The memory 12 is, for example, a random access memory (RAM), and the memory 12 transitorily stores a program or data that is recorded in the storage 14 or the portable recording medium 16 when executing the program.

The input/output interface 13 is a circuit that receives or transmits a signal from/to a device other than the controller 10 (for example, the microscope body 100, the input device 20, the display device 30, or the like). The storage 14 is, for example, a hard disk or a flash memory, and the storage 14 is principally used to record various types of data or programs. The portable recording medium driving device 15 houses the portable recording medium 16 such as an optical disk or a Compact Flash (registered trademark). The portable recording medium 16 has a function of supporting the storage 14. Each of the storage 14 and the portable recording medium 16 is an example of a non-transitory computer-readable medium that records a program.

FIG. 3 illustrates an example of the hardware configuration of the controller 10, and the controller 10 does not always have this configuration. The controller 10 may be a dedicated device rather than a general-purpose device. The controller 10 may include electric circuits such as an application specific integrated circuit (ASIC) or a field programmable gate array (FPGA), instead of or in addition to the processor that executes a program, and these electric circuits may perform the three-dimensional image construction processing described later.

The input device 20 is, for example, a keyboard, a mouse, a touch panel, or the like. The display device 30 is, for example, a liquid crystal display or an organic EL display.

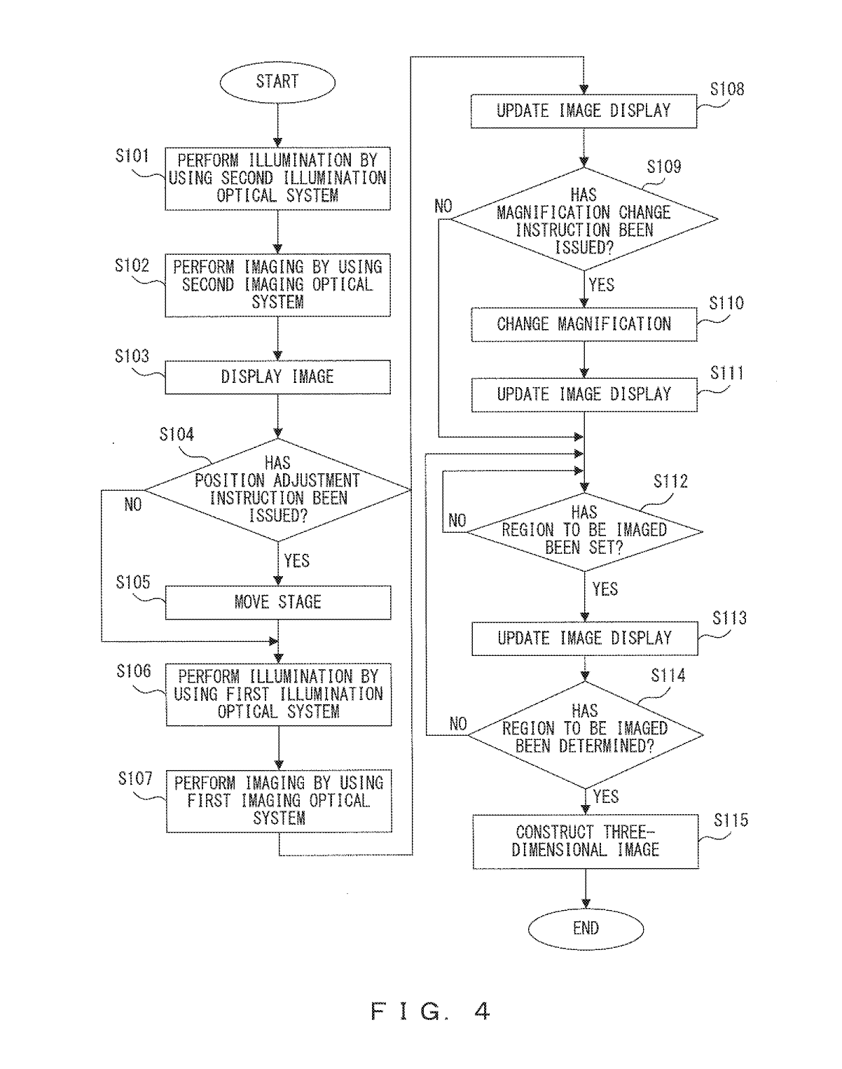

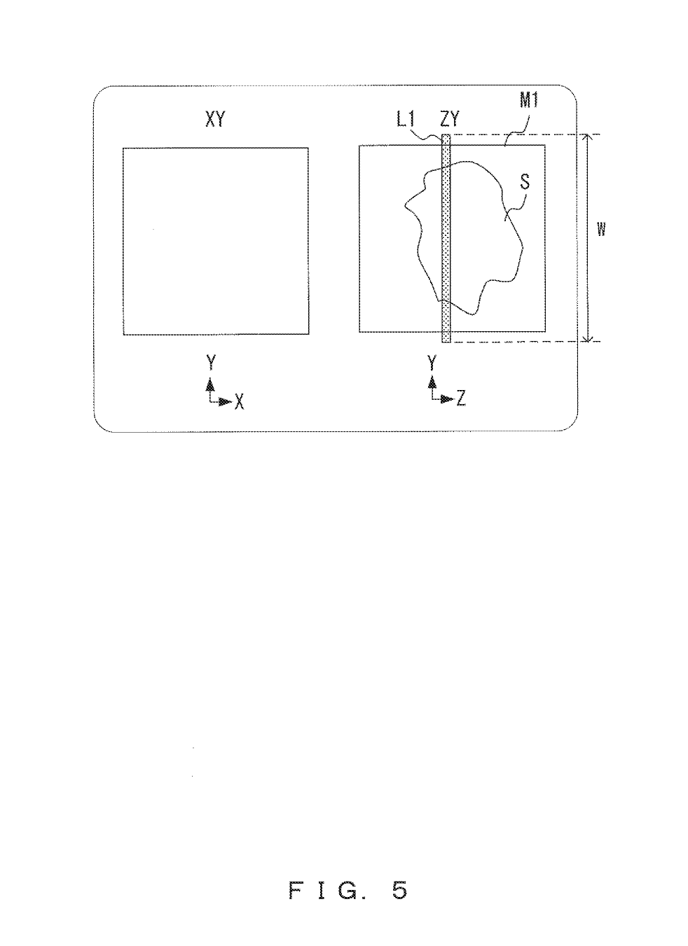

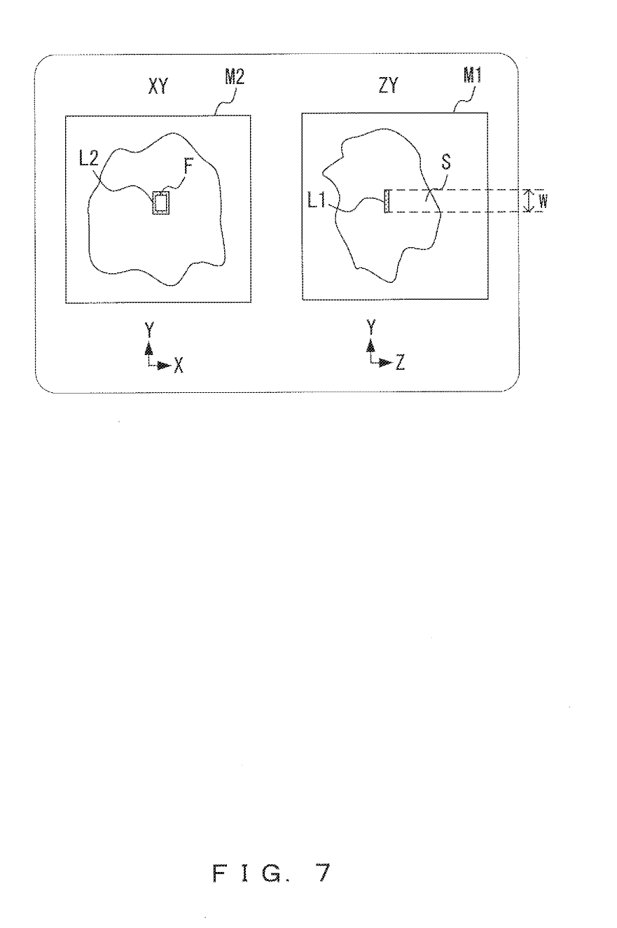

FIG. 4 is an example of a flowchart of three-dimensional image construction processing. FIG. 5 to FIG. 9 illustrate examples of a screen that is displayed on the display device 30 in order to support a task of setting a region to be imaged. The three-dimensional image construction processing performed by the microscope 1 is described below in detail with reference to FIG. 4 to FIG. 9. Description is given by using, as an example, a case in which the three-dimensional image construction processing is started from a state in which the objective 121 is arranged on an imaging optical path and the lens 113 and the cylindrical lens 114 are arranged on an illumination optical path, as illustrated in FIG. 1.

The microscope 1 first illuminates the sample S by using the illumination optical system 130, which is the second illumination optical system (step S101). Here, the illumination optical system 130 illuminates the sample S from a direction that is substantially orthogonal to the optical axis of the objective 121.

The microscope 1 images the sample S by using the imaging optical system 140, which is the second imaging optical system (step S102). Here, the imaging optical system 140, which includes the objective 135 that is substantially orthogonal to the optical axis of the objective 121, images the sample S on the basis of near-infrared light that has been emitted from the illumination optical system 130 and has been reflected by the sample S, and generates a bright-field image. The total projection magnification of the imaging optical system 140 is, for example, 1×, and the bright-field image is, for example, an image of 1×.

The microscope 1 displays the image of the sample S captured by the imaging optical system 140 (step S103). Here, the controller 10 first obtains a bright-field image M1 of the sample S from the imaging optical system 140. Further, the controller 10 causes the display device 30 to display the bright-field image M1 and an illumination mark L1 that is position information indicating the position of an illumination region formed by the illumination optical system 130. More specifically, as illustrated in FIG. 5, for example, the controller 10 causes the display device 30 to display a combined image in which the illumination mark L1 is superimposed onto a region that corresponds to the illumination region (hereinafter referred to as an illumination corresponding region) within the bright-field image M1. The illumination mark L1 maybe any information that sections a region in an image. The width of the illumination mark L1 corresponds to the width W of a light sheet formed by the illumination optical system 110. By doing this, a user of the microscope 1 can easily grasp which range of the sample S is illuminated when the sample S is illuminated by using the illumination optical system 110.

The illumination corresponding region within the bright-field image M1 is calculated according to the setting of the microscope 1. Specifically, as an example, the size of the illumination region is first determined according to the aperture diameter of an optical system and the diaphragm 115 that are arranged on the illumination optical path of the illumination optical system 110. The size of the illumination corresponding region within the bright-field image M1 is determined according to the total projection magnification of the imaging optical system 140. Further, the position of the illumination corresponding region is determined from a positional relationship between the illumination optical axis of the illumination optical system 110 and the optical axis of the objective 135. In the microscope 1, the illumination optical axis of the illumination optical system 110 and the optical axis of the objective 135 are located on the same axis, and therefore the illumination corresponding region is located at the center of the bright-field image M1.

When an instruction to adjust the position of the illumination region is issued from a user who has viewed the image displayed on the display device 30 (YES in step S104), the microscope 1 moves the electric stage 101 (step S105). Here, the controller 10 controls the electric stage 101. The controller 10 may move the bright-field image M1 relative to the illumination mark L1 according to the movement of the electric stage 101, and may update the combined image displayed on the display device 30.

The microscope 1 illuminates the sample S by using the illumination optical system 110, which is the first illumination optical system (step S106), and images the sample S by using the imaging optical system 120, which is the first imaging optical system (step S107). Here, the illumination optical system 110 illuminates the sample S from a direction that is substantially orthogonal to the optical axis of the objective 121, and forms an illumination region by using the light sheet LS. The imaging optical system 120 images the sample S on the basis of fluorescence generated from the illumination region, and generates a fluorescence image. The total projection magnification of the imaging optical system 120 is, for example, 1×, and the fluorescence image is, for example, an image of 1×.

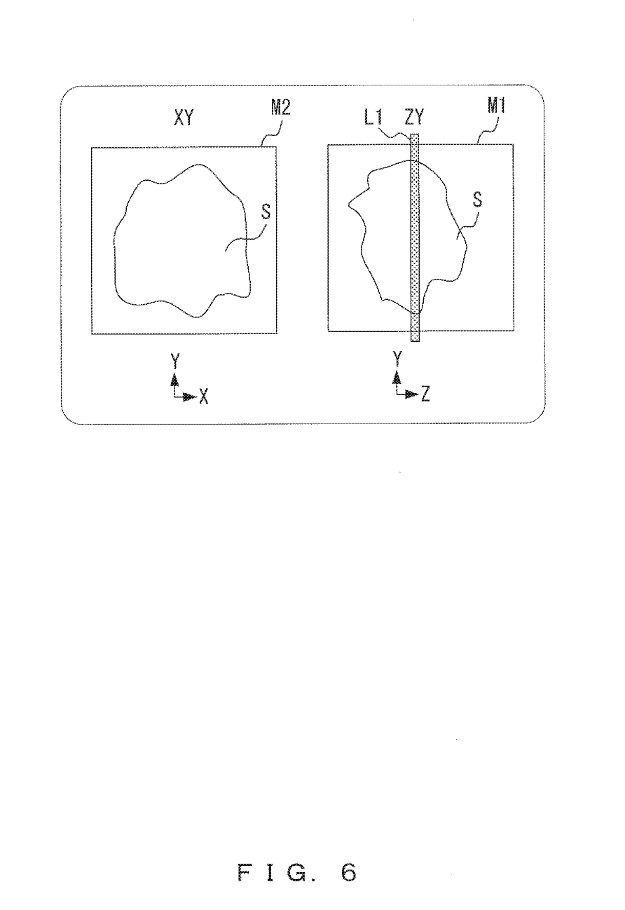

The microscope 1 updates an image display on the display device 30 (step S108). Here, the controller 10 first obtains a fluorescence image M2 of the sample S from the imaging optical system 120. Further, the controller 10 updates the image display on the display device 30 in such a way that the fluorescence image M2 is displayed next to the combined image that is formed by the bright-field image M1 and the illumination mark L1, as illustrated in FIG. 6. By doing this, a user of the microscope 1 can simultaneously confirm a tomographic image of the sample S (the fluorescence image M2) and an image of the sample S viewed from the side (the bright-field image M1), and can grasp the shape and the like of the sample S.

When an instruction to change a magnification is issued from a user who has viewed an image displayed on the display device 30 (YES in step S109), the microscope 1 changes the magnification (step S110). Here, the controller 10 controls the driving device 127 so as to cause the driving device 127 to rotate the turret 128 in such a way that the objective 126 that corresponds to the magnification (for example, 10×) instructed by the user is located on the imaging optical path. In addition, the controller 10 controls the driving device 118 so as to rotate the turret 119 in such a way that an optical system (for example, the lens 116 and the cylindrical lens 117) that corresponds to the objective 126 arranged on the imaging optical path is located on the illumination optical path. Further, the controller 10 changes the aperture diameter of the diaphragm 115 to an aperture diameter that corresponds to the objective 126.

When the magnification is changed, the microscope 1 updates the image display on the display device 30 (step S111). Here, the controller 10 first calculates the size of an illumination corresponding region on the bright-field image M1 and the size of an illumination corresponding region within the fluorescence image M2, and further calculates the size of a region that corresponds to a field of view (hereinafter referred to as a visual-field corresponding region) within the fluorescence image M2. The controller 10 causes the display device 30 to display a combined image in which the illumination mark L1 is superimposed onto the calculated illumination corresponding region within the bright-field image M1. The width of the illumination mark L1 corresponds to the width W of the light sheet formed by the illumination optical system 110. Further, the controller 10 causes the display device 30 to display a combined image in which an illumination mark L2 is superimposed onto the calculated illumination corresponding region within the fluorescence image M2 and a visual-field mark F is superimposed onto the calculated visual-field corresponding region.

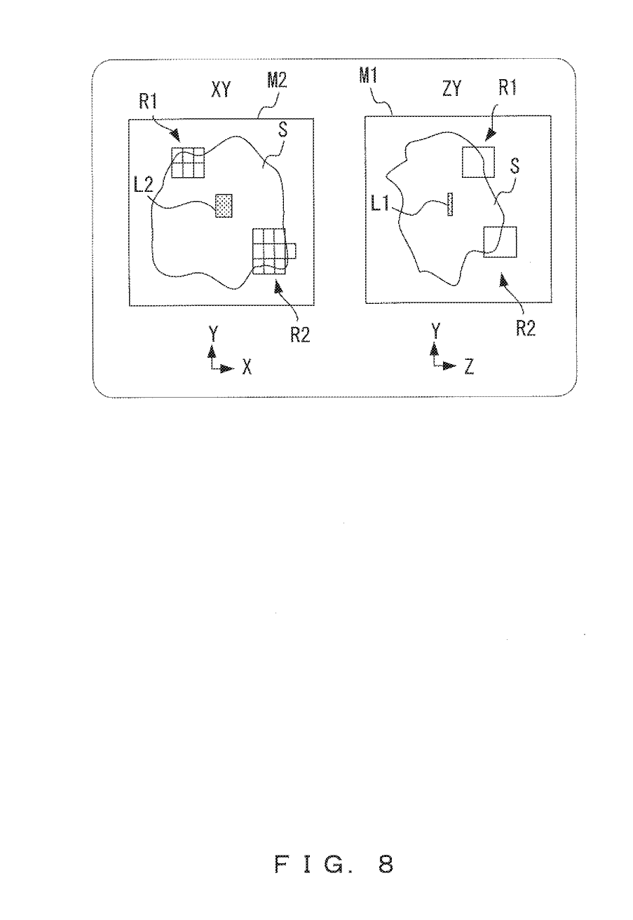

The microscope 1 receives the specification of a region to be imaged from a user. The user specifies a region to be imaged on a screen by using the input device 20. The region to be imaged, which is a three-dimensional region, is specified when the user specifies each of a two-dimensional region on the fluorescence image M2 and a two-dimensional region on the bright-field image Ml. FIG. 8 illustrates an example in which two three-dimensional regions (region R1 and region R2) that are separated from each other are specified as a region to be imaged by the user. Small regions that configure the two-dimensional region specified on the fluorescence image M2 indicate the size of the visual-field corresponding region.

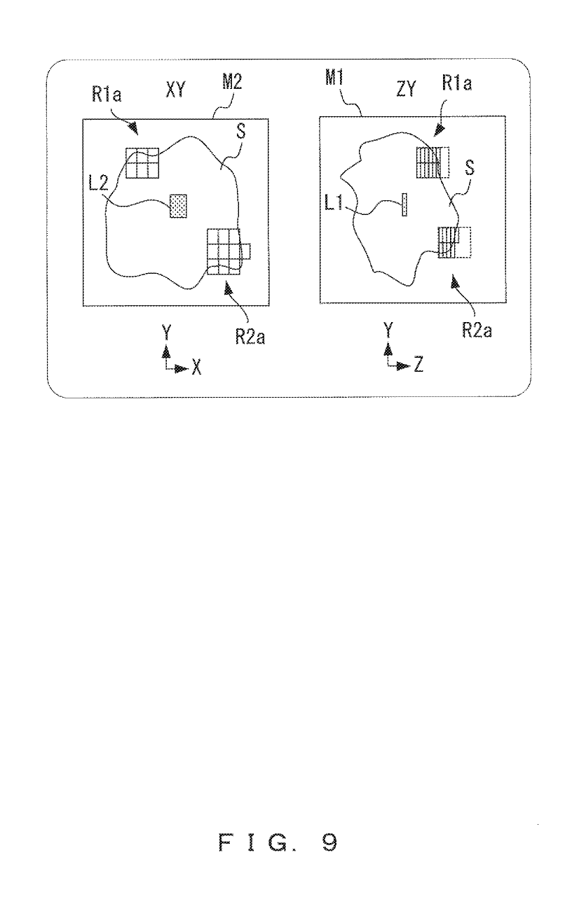

When the specified region to be imaged is set (YES in step S112), the microscope 1 updates the image display on the display device 30 (step S113). Here, the controller 10 sections the two-dimensional region specified on the bright-field image M1 at each imaging pitch (each interval between tomographic images) so as to generate a plurality of small regions. The imaging pitch is set automatically or manually in the microscope 1. The controller 10 updates the image display on the display device 30 such that a region (region R1a and region R2a) excluding small regions outside the sample S is displayed, as illustrated in FIG. 9.

When the region to be imaged is determined by a user who has confirmed the updated image display (YES instep S114), the microscope 1 constructs a three-dimensional image of the set region to be imaged (step S115). Here, the microscope body 100 images a plurality of tomographic images within the region to be imaged, and the controller 10 performs image processing on the plurality of tomographic images obtained by the microscope body 100 such that a three-dimensional image is constructed.

As described above, the microscope 1 includes the illumination optical system 130 and the imaging optical system 140, and therefore an image of the sample S viewed from the side can be obtained. Therefore, by displaying an illumination region on an image, a positional relationship between the sample S and the illumination region and, in particular, a positional relationship in a depth direction can be easily grasped. Accordingly, the accurate setting of a region to be imaged when constructing a three-dimensional image can be supported.

In addition, in the microscope 1, the illumination optical system 130 emits light having a wavelength that is longer than the wavelength of light emitted from the illumination optical system 110 and that does not excite a fluorescent material within the sample S. Therefore, a positional relationship between the sample S and the illumination region can be grasped while preventing the sample S from discoloring. Accordingly, a region to be imaged can be accurately set while suppressing the deterioration of a tomographic image used to construct a three-dimensional image.

Further, the microscope 1 causes the display device 30 to display an image of the sample S that has been captured by the imaging optical system 120 in addition to an image of the sample S that has been captured by the imaging optical system 140. Therefore, the three-dimensional shape of the sample S can be grasped, and a region to be imaged can be set more easily. In the microscope 1, the visual-field mark F and the illumination marks (L1 and L2) are displayed on an image. These marks are useful in that a user is assisted in selecting an objective according to the purpose.

It is preferable that two images displayed on the display device 30 have the same magnification. This is because the entire shape of the sample S can be easily grasped when the magnifications of images captured from different directions are the same as each other. Therefore, it is preferable that the total projection magnification of the imaging optical system 140 be equal to the lowest total projection magnification of the imaging optical system 120 including a plurality of objectives. In other words, it is preferable that the imaging range of the imaging optical system 140 be wider than or equal to the imaging range of the imaging optical system 120.

### Second Embodiment

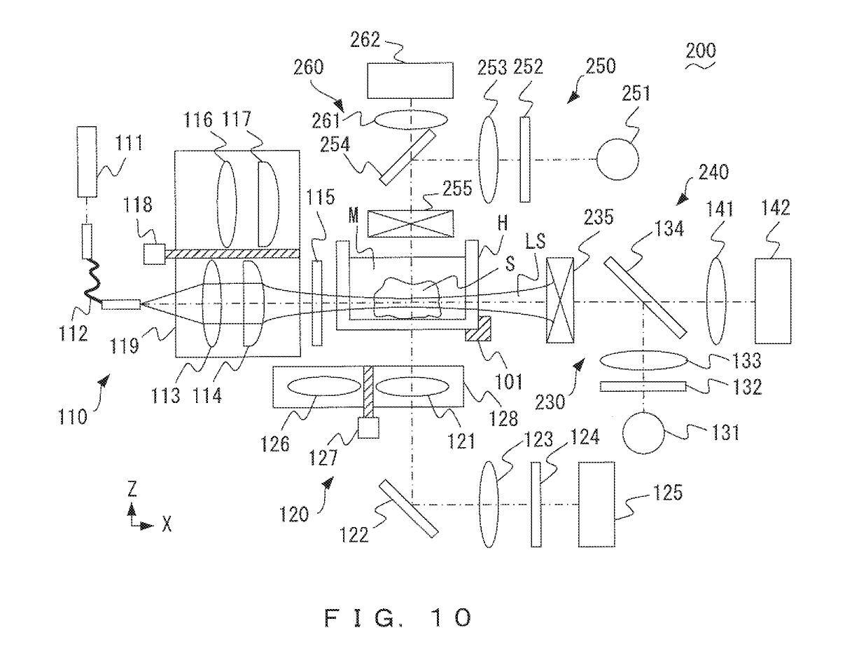

FIG. 10 illustrates the configuration of a microscope body 200 according to this embodiment. A microscope according to this embodiment is a light sheet microscope, and is different from the microscope 1 in that the microscope body 200 is included instead of the microscope body 100. The other configuration is similar to that of the microscope 1.

The microscope body 200 is different from the microscope body 100 in that an illumination optical system 230 and an imaging optical system 240 are included instead of the illumination optical system 130 and the imaging optical system 140 and in that an illumination optical system 250 and an imaging optical system 260 are included. The other configuration is similar to that of the microscope body 100.

The illumination optical system 230 is a second illumination optical system of the microscope according to this embodiment, and the illumination optical system 230 illuminates the sample S from a direction that is substantially orthogonal to the optical axis of the objective 121. In addition, the imaging optical system 240 is a second imaging optical system of the microscope according to this embodiment, and the imaging optical system 240 images the sample S on the basis of light emitted from the illumination optical system 230.

The illumination optical system 230 and the imaging optical system 240 are different from the illumination optical system 130 and the imaging optical system 140 in that an objective 235 is included instead of the objective 135. The objective 235 is a zoom objective that has a zoom function for continuously changing a magnification, and the objective 235 is a first zoom optical system of the microscope according to this embodiment. The magnification of the objective 235 is controlled by the controller 10.

The illumination optical system 250 is a third illumination optical system of the microscope according to this embodiment, and the illumination optical system 250 illuminates the sample S from a direction that is substantially parallel to the optical axis of the objective 121. The illumination optical system 250 is a reflection illumination optical system that shares some optical elements with the imaging optical system 260. The illumination optical system 250 includes a light source 251, a wavelength selection filter 252, an illumination lens 253, a half mirror 254, and an objective 255.

The light source 251 is, for example, a halogen lamp. The light emission of the light source 251 is controlled by the controller 10. The wavelength selection filter 252 transmits light having a wavelength that does not excite a fluorescent material within the sample S of light emitted from the light source 251 and, more specifically, near-infrared light having a wavelength that is longer than the excitation wavelength of the sample S. The near-infrared light enters the objective 255 via the illumination lens 253 and the half mirror 254.

The objective 255 is a zoom objective that has a zoom function for continuously changing a magnification, and is a third objective of the microscope according to this embodiment, and is a second zoom optical system. The magnification of the objective 255 is controlled by the controller 10. In addition, the objective 255 is arranged so as to face the objective 121 across the sample S. More specifically, the objective 255 is arranged in such a way that the optical axis of the objective 121 and the optical axis of the objective 255 are located on the same axis. The near-infrared light is applied to the sample S by the objective 255. By doing this, the sample S is illuminated from a direction that is substantially parallel to the optical axis of the objective 121. The phrase “substantially parallel” means a range that those skilled in the art can recognize as errors in setting or manufacturing, and includes “parallel”.

The imaging optical system. 260 is a third imaging optical system of the microscope according to this embodiment, and the imaging optical system 260 images the sample S on the basis of light emitted from the illumination optical system 250. The imaging optical system 260 includes the objective 255, the half mirror 254, a tube lens 261, and an imaging device 262. The objective 255 and the half mirror 254 are shared with the illumination optical system 250.

Near-infrared light reflected by the sample S of the near-infrared light emitted by the illumination optical system 250 enters the tube lens 261 via the objective 255 and the half mirror 254. The tube lens 261 condenses the near-infrared light and forms an optical image on the imaging device 262. The imaging device 262 is, for example, a digital camera that includes a two-dimensional image sensor such as a charge coupled device (CCD) or a complementary metal oxide semiconductor (CMOS). The imaging device 262 generates bright-field image data on the basis of the optical image, and transmits the generated bright-field image data to the controller 10.

In the microscope body 200, the total projection magnification of the imaging optical system. 240 is equal to the total projection magnification of the imaging optical system 260. Specifically, the controller 10 controls the magnification of the objective 235 and the magnification of the objective 255 in such a way that the total projection magnification of the imaging optical system. 240 is equal to the total projection magnification of the imaging optical system 260. Namely, the controller 10 is a magnification controller that controls the magnifications of the objective 235 and the objective 255.

The microscope according to this embodiment also performs processing that is similar to the three-dimensional image construction processing illustrated in FIG. 4, except that the third illumination optical system performs illumination in step S106 and the third imaging optical system performs imaging in step S107. By doing this, effects that are similar to those in the microscope 1 can be obtained.

Further, in the microscope according to this embodiment, an image to be displayed on the display device 30 in order to support the setting of a region to be imaged is obtained by the illumination optical system 250 and the imaging optical system 260 instead of the illumination optical system 110 and the imaging optical system 120. A fluorescence image is not obtained in order to set a region to be imaged, and therefore the region to be imaged can be accurately set while preventing the sample S from discoloring. In addition, the imaging optical system 240 and the imaging optical system 260 include a zoom optical system, and therefore samples having various sizes can be handled. Further, control is performed in such a way that the total projection magnification of the imaging optical system 240 is equal to the total projection magnification of the imaging optical system 260, and therefore the three-dimensional shape of the sample S can be easily grasped.

### Third Embodiment

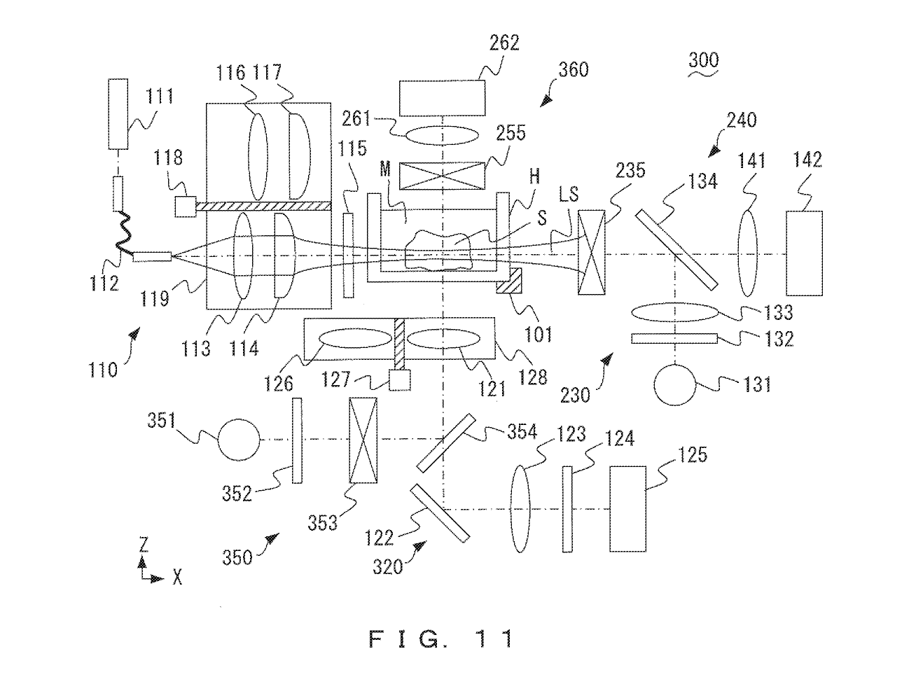

FIG. 11 illustrates the configuration of a microscope body 300 according to this embodiment. A microscope according to this embodiment is a light sheet microscope, and is different from the microscope according to the second embodiment in that the microscope body 300 is included instead of the microscope body 200. The other configuration is similar to that of the microscope according to the second embodiment.

The microscope body 300 is similar to the microscope body 200 in that a third illumination optical system (an illumination optical system 350) is included that illuminates the sample S from a direction of the optical axis of the objective 121. However, the microscope body 300 is different from the microscope body 200 in that the third illumination optical system is not configured to be a reflection illumination optical system that shares some optical elements with a third imaging optical system, but is configured to be a transmission illumination optical system that shares some optical elements with a first imaging optical system.

The illumination optical system 350 includes a light source 351, a wavelength selection filter 352, an illumination lens 353, a dichroic mirror 354, and objective lenses (an objective 121 and an objective 126). The dichroic mirror 354 and the objectives are shared with an imaging optical system 320, which is the first imaging optical system.

The light source 351 is, for example, a halogen lamp. The light emission of the light source 351 is controlled by the controller 10. The wavelength selection filter 352 transmits light having a wavelength that does not excite a fluorescent material within the sample S of light emitted from the light source 351 and, more specifically, near-infrared light having a wavelength that is longer than the excitation wavelength of the sample S. The near-infrared light that has passed through the wavelength selection filter 352 enters the objective 121 via the illumination lens 353 and the dichroic mirror 354. The illumination lens 353 is a zoom lens that is controlled by the controller 10. The dichroic mirror 354 has a characteristic whereby infrared light is reflected and visible light is transmitted. The near-infrared light is applied to the sample S by the objective 121. By doing this, the sample S is illuminated from a direction of the optical axis of the objective 121.

Further, the third illumination optical system is configured to be a transmission illumination optical system, and therefore the microscope body 300 is also different from the microscope body 200 in that the imaging optical system 320 is included instead of the imaging optical system 120 and in that an imaging optical system 360 is included instead of the imaging optical system 260.

The imaging optical system 320 is different from the imaging optical system 120 in that the dichroic mirror 354 is included, but in the other respects, the imaging optical system 320 is similar to the imaging optical system. 120. In addition, the imaging optical system 360 is different from the imaging optical system 260 in that the half mirror 254 is not included, but in the other respects, the imaging optical system 360 is similar to the imaging optical system 260.

The microscope according to this embodiment also performs processing that is similar to the three-dimensional image construction processing illustrated in FIG. 4, except that the third illumination optical system performs illumination in step S106 and the third imaging optical system performs imaging in step S107. By doing this, effects that are similar to those in the microscope according to the second embodiment can be obtained.

### Fourth Embodiment

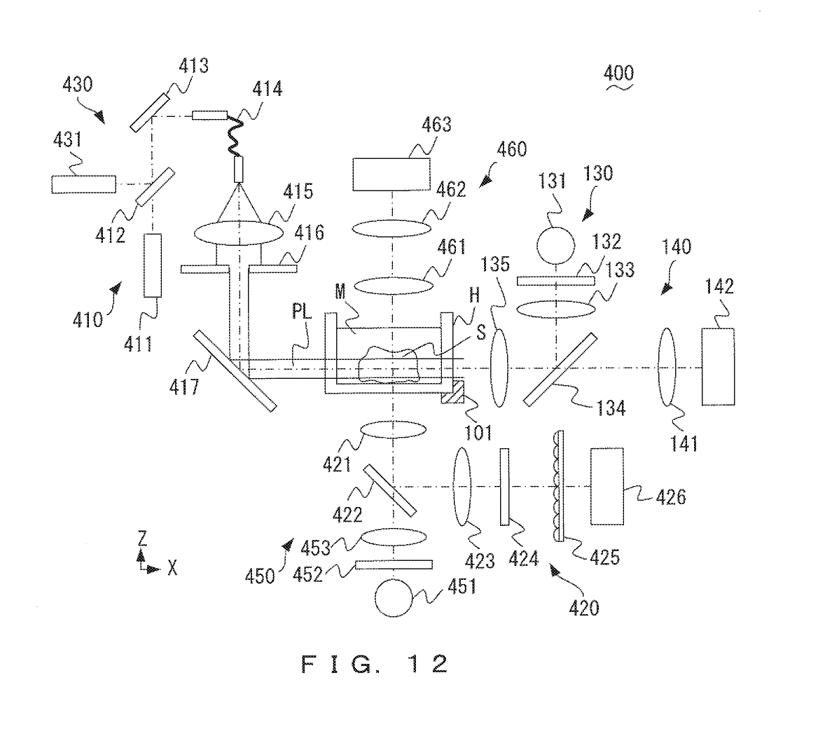

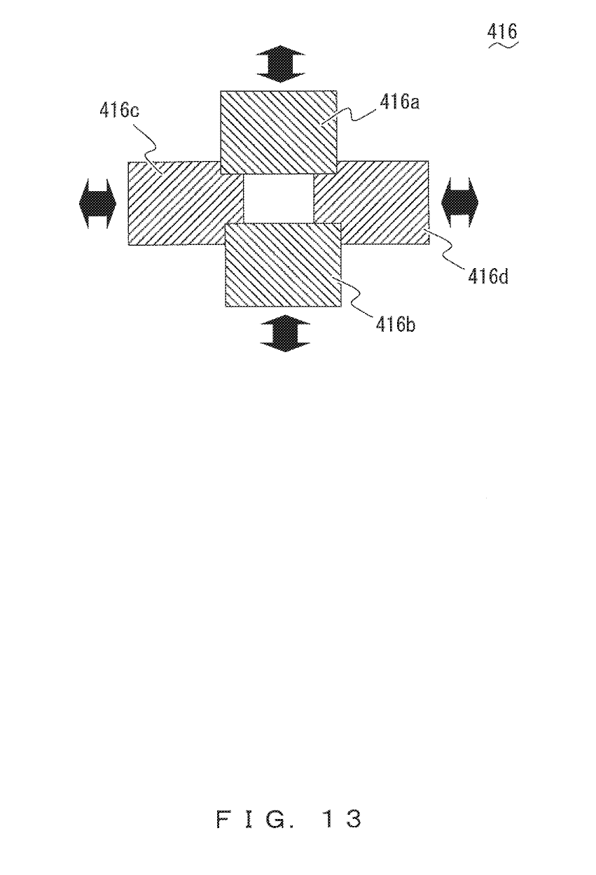

FIG. 12 illustrates the configuration of a microscope body 400 according to this embodiment. FIG. 13 is a diagram explaining the configuration of a diaphragm 416. A microscope according to this embodiment is a light field microscope, and is different from the microscope 1 in that the microscope body 400 is included instead of the microscope body 100. The other configuration is similar to that of the microscope 1.

The microscope body 400 includes an illumination optical system 410 that irradiates the sample S with a parallel light flux PL for which a sectional shape is rectangular, and an imaging optical system 420 that obtains a fluorescence image of the sample S.

The illumination optical system 410 is a first illumination optical system of the microscope according to this embodiment. The illumination optical system 410 includes a laser 411, a dichroic mirror 412, a mirror 413, an optical fiber 414, a lens 415, a diaphragm 416, and a mirror 417. The diaphragm 416 includes four blades (a blade 416a, a blade 416b, a blade 416c, and a blade 416d) that are controlled by the controller 10, as illustrated in FIG. 13. The controller 10 controls the four blades in such a way that the center of an aperture is maintained on the optical axis of the lens 415.

The laser 411 is a visible-light laser that emits visible light, and the laser 411 emits, for example, a laser beam having a wavelength of 488 nm. The ON/OFF state of the laser 411 and the intensity of the laser beam are controlled by the controller 10. The laser beam is guided to the optical fiber 414 via a collecting optical system that is not illustrated, the dichroic mirror 412, and the mirror 413. The laser beam that has exited from the optical fiber 414 is converted into a parallel light flux by the lens 415. The parallel light flux PL having a rectangular sectional shape that has passed through the diaphragm 416 is reflected by the mirror 417, and is applied to the sample S from a direction that is substantially orthogonal to the optical axis of the objective 421. The size of the aperture of the diaphragm 416 is adjusted in advance by the controller 10 so as to be a size that corresponds to the depth of focus of the imaging optical system 420 described later. By doing this, an illumination region (a first illumination region) that has a thickness that corresponds to the depth of focus of the imaging optical system 420 is formed within the sample S.

The imaging optical system 420 is a first imaging optical system of the microscope according to this embodiment, and is a light field optical system. The imaging optical system 420 includes an objective 421, a dichroic mirror 422, a tube lens 423 that forms an optical image of the sample S, an emission filter 424, a microlens array 425, and an imaging device 426.

The objective 421 is an infinity-corrected objective, and is a first objective of the microscope according to this embodiment. In the sample S irradiated with the parallel light flux PL by the illumination optical system 410, fluorescence is generated in the illumination region of the sample S. The fluorescence generated from the illumination region enters the objective 421, is converted into a parallel light flux by the objective 421, and enters the tube lens 423 via the dichroic mirror 422. The fluorescence enters the imaging device 426 via the tube lens 423, the emission filter 424, and the microlens array 425 that is arranged between the tube lens 423 and the imaging device 426 and near a focal plane of the tube lens 423. A laser beam that has been scattered by the sample S and has entered the imaging optical system 420 together with the fluorescence is shielded by the dichroic mirror 422 and the emission filter 424. The imaging device 426 is, for example, a digital camera that includes a two-dimensional image sensor such as a charge coupled device (CCD) or a complementary metal oxide semiconductor (CMOS). The imaging device 426 generates fluorescence image data on the basis of the fluorescence incident via the microlens array 425, and transmits the generated fluorescence image data to the controller 10. The fluorescence image data generated by the imaging optical system 420 includes three-dimensional data.

The illumination optical system 410 and the imaging optical system 420 that are configured as described above are arranged in such a way that respective optical axes are substantially orthogonal to each other. More specifically, the illumination optical system 410 and the imaging optical system 420 are provided in such a way that the illumination optical axis of the illumination optical system 410 is substantially orthogonal to the optical axis of the objective 421 included in the imaging optical system 420. Therefore, in the microscope body 400, the illumination optical system 410 illuminates the sample S from a direction (a first direction) that is substantially orthogonal to the optical axis of the objective 421, and forms an illumination region having a thickness that corresponds to the depth of focus of the imaging optical system 420 within the sample S.

The microscope body 400 further includes an illumination optical system 130 and an imaging optical system 140 similarly to the microscope body 100. The illumination optical system 130 is a second illumination optical system of the microscope according to this embodiment, and the illumination optical system 130 illuminates the sample S from a direction that is substantially orthogonal to the optical axis of the objective 421. The imaging optical system 140 is a second imaging optical system of the microscope according to this embodiment, and the imaging optical system 140 images the sample S on the basis of light emitted from the illumination optical system 130.

The microscope body 400 further includes an illumination optical system 430. The illumination optical system 430 is an illumination optical system that illuminates the sample S from a direction that is substantially orthogonal to the optical axis of the objective 421 and a direction that is the same as a direction from which the illumination optical system 410 serving as the first illumination optical system does. The illumination optical system 430 functions as a second illumination optical system similarly to the illumination optical system 130.

The illumination optical system 430 is a transmission illumination optical system that shares some optical elements with the first illumination optical system 410, and the illumination optical system 430 includes a laser 431, the dichroic mirror 412, the mirror 413, the optical fiber 414, the lens 415, the diaphragm 416, and the mirror 417. Optical elements other than the laser 431 are shared with the illumination optical system 410.

The laser 431 is a laser that emits near-infrared light, and the light emission of the laser 431 is controlled by the controller 10. The near-infrared light emitted from the laser 431 is guided to the optical fiber 414 via the dichroic mirror 412 and the mirror 413. The laser beam that has exited from the optical fiber 414 is converted into a parallel light flux by the lens 415. The controller 10 causes the laser 431 to emit light after the controller 10 adjusts the aperture of the diaphragm 416 to have a sufficiently large size (for example, the maximum size). Therefore, near-infrared light having a large diameter of a light flux is applied to the sample S via the mirror 417. The imaging optical system 140 may image the sample S on the basis of light emitted from the illumination optical system 430, namely, near-infrared light that has passed through the sample S.

The microscope body 400 further includes an illumination optical system 450 and an imaging optical system 460. The illumination optical system 450 is a third illumination optical system of the microscope according to this embodiment, and the illumination optical system 450 illuminates the sample S from a direction of the optical axis of the objective 421. The imaging optical system 460 is a third imaging optical system of the microscope according to this embodiment, and the imaging optical system 460 images the sample S on the basis of light emitted from the illumination optical system 450.

The illumination optical system 450 is a transmission illumination optical system that shares some optical elements with the imaging optical system 420, and the illumination optical system 450 includes a light source 451, a wavelength selection filter 452, an illumination lens 453, the dichroic mirror 422, and the objective 421. The objective 421 and the dichroic mirror 422 are shared with the imaging optical system 420.

The light source 451 is, for example, a halogen lamp, and the light emission of the light source 451 is controlled by the controller 10. The wavelength selection filter 452 transmits light having a wavelength that does not excite a fluorescent material in the sample S of light emitted from the light source 451 and, more specifically, near-infrared light having a wavelength that is longer than the excitation wavelength of the sample S. The near-infrared light enters the objective 421 via the illumination lens 453 and the dichroic mirror 422, and is applied to the sample S by the objective 421. By doing this, the sample S is illuminated from a direction of the optical axis of the objective 421.

The imaging optical system. 460 includes an objective 461, a tube lens 462, and an imaging device 463. Near-infrared light that has passed through the sample S of near-infrared light emitted from the illumination optical system 450 enters the tube lens 462 via the objective 461. The tube lens 462 collects the near-infrared light, and forms an optical image on the imaging device 463. The imaging device 463 is a digital camera including a two-dimensional image sensor such as a charge coupled device (CCD) or a complementary metal oxide semiconductor (CMOS). The imaging device 463 generates bright-field image data on the basis of the optical image, and transmits the generated bright-field image data to the controller 10.

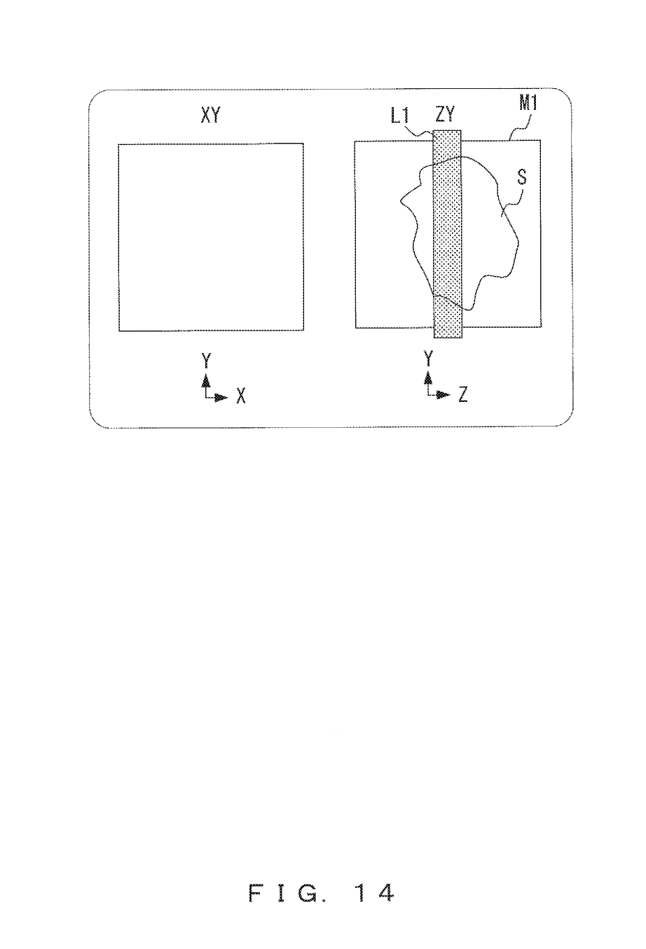

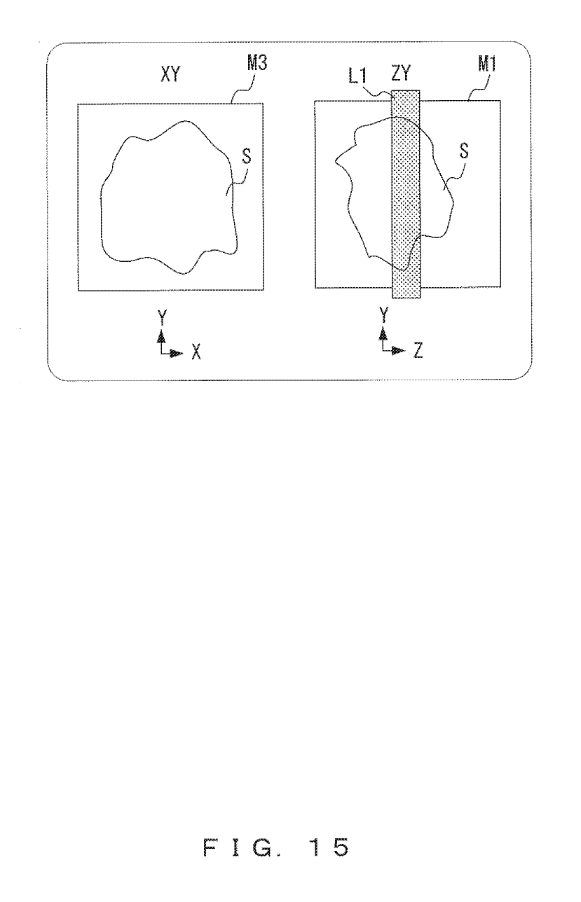

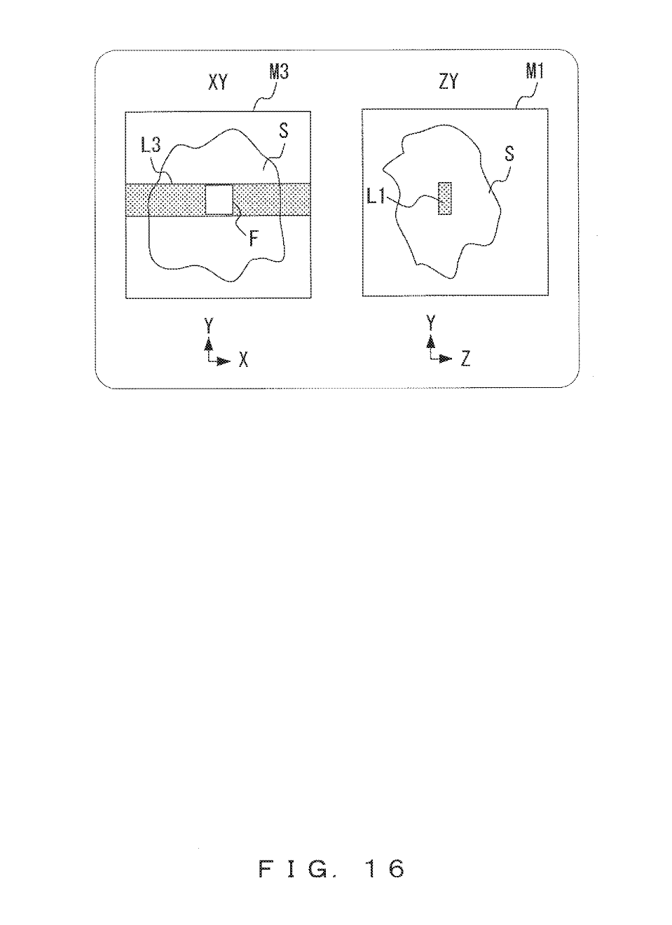

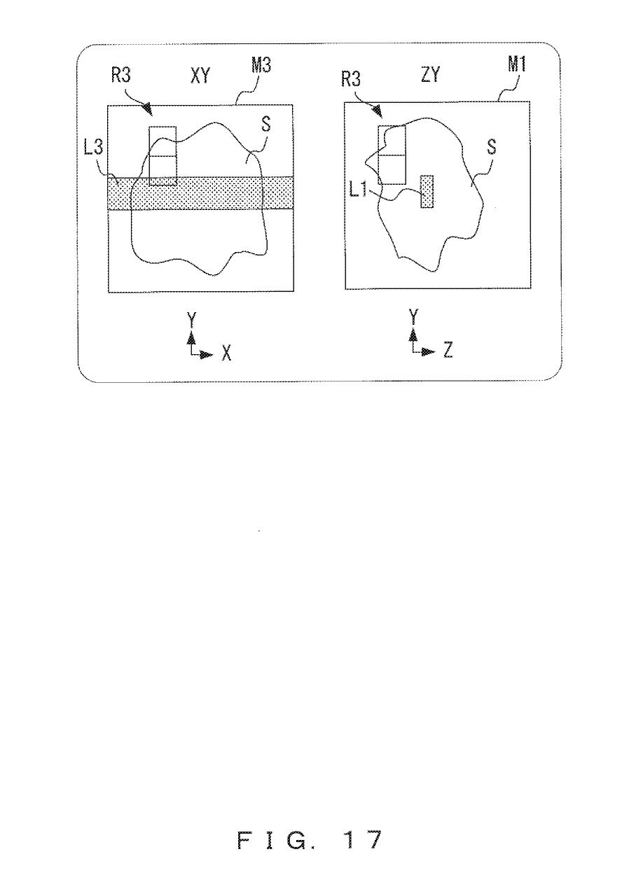

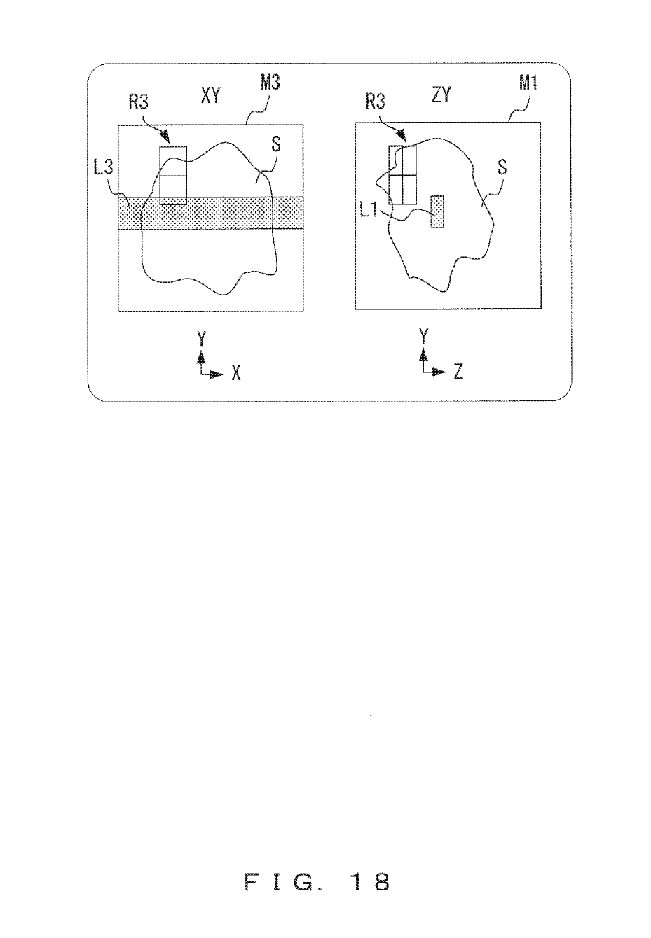

The microscope according to this embodiment also performs processing that is similar to the three-dimensional image construction processing illustrated in FIG. 4, except that the third illumination optical system performs illumination in step S106 and the third imaging optical system performs imaging in step S107. FIG. 14 to FIG. 18 illustrate examples of a screen that is displayed on the display device 30 in order to support a task of setting a region to be imaged. FIG. 14, FIG. 15, and FIG. 16 respectively illustrate examples of screens displayed in step S103, step S108, and step S111. FIG. 17 illustrates an example of a screen that is displayed while a user is specifying a region to be imaged in step S112. FIG. 18 illustrates an example of a screen displayed in step S113. FIG. 18 illustrates an example in which a two-dimensional region R3 specified on a bright-field image M1 is sectioned in a Z-direction into two regions on the basis of the depth of focus of the imaging optical system 420 so as to generate a plurality of small regions. By employing the microscope according to this embodiment, effects that are similar to the effects in the microscope according to the second embodiment can be obtained.

The illumination optical system 410 and the illumination optical system 130 may simultaneously illuminate the sample S. The controller 10 may cause the display device 30 to display an image of the sample S that has been captured by the imaging optical system 140 while the illumination optical system 410 and the illumination optical system 130 are illuminating the sample S. In this case, the controller 10 can confirm a position in which an illumination region is actually formed because an illumination corresponding region in the image becomes bright. In addition, an illumination mark L1 does not need to be superimposed and displayed onto the image obtained by the imaging optical system 140.

In addition, in order to suppress discoloring, the illumination optical system 430 may be used instead of the illumination optical system 410. Namely, the controller 10 may cause the display device 30 to display an image of the sample S that has been captured by the imaging optical system 140 while the illumination optical system 430 and the illumination optical system 130 are illuminating the sample S. In this case, the controller 10 may cause the illumination optical system 410 and the illumination optical system 430 to illuminate the sample S after the controller 10 adjusts the size of an aperture of the diaphragm 416 to be a size that corresponds to the depth of field (the depth of focus) of the imaging optical system 420.

The embodiments described above give specific examples in order to make the invention easily understandable, and the embodiments of the present invention are not limited to the embodiments described above. Various modifications or variations can be made to a microscope and a setting support method without departing from the recitation of the claims. The first to third illumination optical systems may be configured to be a transmission illumination optical system, or may be configured to be a reflection illumination optical system. In addition, both the transmission illumination optical system and the reflection illumination optical system may be provided such that an illumination optical system to be used can be selected according to a reflectance and a transmittance of a sample to be observed.

What is claimed is:

1. A microscope comprising:
a first illumination optical system that illuminates a sample from a first direction that is substantially orthogonal to an optical axis of a first objective, and that forms a first illumination region within the sample;
a first imaging optical system that includes the first objective, the first imaging optical system imaging the sample in accordance with light that has been generated from the first illumination region formed by the first illumination optical system;
a second illumination optical system that illuminates the sample from a second direction that is substantially orthogonal to the optical axis of the first objective; and
a second imaging optical system that includes a second objective having an optical axis that is substantially orthogonal to the optical axis of the first objective, the second imaging optical system imaging the sample in accordance with light emitted from the second illumination optical system.

2. The microscope according to claim 1, wherein
the second objective and the first illumination optical system are arranged so as to face each other across the sample.

3. The microscope according to claim 2, wherein
the optical axis of the second objective and an illumination optical axis of the first illumination optical system are located on a same axis.

4. The microscope according to claim 1, wherein
the second illumination optical system is a reflection illumination optical system that shares some optical elements with the second imaging optical system.

5. The microscope according to claim 1, wherein
the first direction and the second direction are a same direction, and
the second illumination optical system is a transmission illumination optical system that shares some optical elements with the first illumination optical system.

6. The microscope according to claim 1, further comprising:
a display controller that causes a display device to display an image of the sample that has been captured by the second imaging optical system, and position information indicating a position of the first illumination region.

7. The microscope according to claim 6, wherein
the position information is a mark that sections a region in the image, and
the display controller causes the display device to display a combined image in which the position information is superimposed onto a region that corresponds to the first illumination region within the image.

8. The microscope according to claim. 5, further comprising:
a display controller that causes a display device to display an image of the sample that has been captured by the second imaging optical system while the first illumination optical system and the second illumination optical system are illuminating the sample.

9. The microscope according to claim 1, wherein
a wavelength of light with which the second illumination optical system irradiates the sample is longer than a wavelength of light with which the first illumination optical system irradiates the sample.

10. The microscope according to claim 9, wherein
the first illumination optical system irradiates the sample with visible light, and
the second illumination optical system irradiates the sample with near-infrared light.

11. The microscope according to claim 1, further comprising:
a third illumination optical system that illuminates the sample from a third direction that is substantially parallel to the optical axis of the first objective; and
a third imaging optical system that includes a third objective that is arranged so as to face the first objective across the sample, the third imaging optical system imaging the sample in accordance with light emitted from the third illumination optical system.

12. The microscope according to claim 11, wherein
the optical axis of the first objective and an optical axis of the third objective are located on a same axis.

13. The microscope according to claim 11, wherein
the third illumination optical system is a reflection illumination optical system that shares some optical elements with the third imaging optical system.

14. The microscope according to claim 11, wherein
the third illumination optical system is a transmission illumination optical system that shares some optical elements with the first imaging optical system.

15. The microscope according to claim 11, wherein
a total projection magnification of the second imaging optical system is equal to a total projection magnification of the third imaging optical system.

16. The microscope according to claim 11, wherein
the second imaging optical system includes a first zoom optical system,
the third imaging optical system include a second zoom optical system, and
the microscope further includes:
a magnification controller that controls a magnification of the first zoom optical system and the magnification of the second zoom optical system in such a way that a total projection magnification of the second imaging optical system is equal to a total projection magnification of the third imaging optical system.

17. The microscope according to claim 1, further comprising:
a driving device that changes a relative positional relationship between the sample and the first illumination region.

18. The microscope according to claim 1, wherein
the microscope is a light sheet microscope, and
the first illumination optical system forms the first illumination region by using a light sheet.

19. The microscope according to claim 1, wherein
the microscope is a light field microscope, and
the first imaging optical system includes:
a tube lens that forms an image of the sample;
an imaging device; and
a microlens array that is arranged between the tube lens and the imaging device.

20. A setting support method that supports a task of setting a region to be imaged by using a microscope that images, via a first objective, a sample illuminated from a first direction that is substantially orthogonal to an optical axis of the first objective, the setting support method comprising:
illuminating the sample from a second direction that is substantially orthogonal to the optical axis of the first objective; and
imaging the sample illuminated from the second direction via a second objective having an optical axis that is substantially orthogonal to the optical axis of the first objective.
